(19) United States
(12) Patent Application Publication
(10) Pub. No.: US 2007/0091232 A1
(43) Pub. Date: Apr. 26, 2007

(54) Flexible liquid crystal display and manufacturing method thereof

(75) Inventors: Sang-il Kim, Gyeonggi-do (KR); Wang-su Hong, Gyeonggi-do (KR); Hyung-il Jeon, Incheon city (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/506,950

(22) Filed: Aug. 18, 2006

(30) Foreign Application Priority Data
Oct. 21, 2005 (KR) 2005-0099823

(51) Int. Cl. G02F 1/1335

(52) U.S. Cl. 349/113

(57) ABSTRACT

A flexible liquid crystal display (LCD), includes a first substrate having a first plastic substrate that has a convex-concave pattern formed thereon and a reflective layer formed on the convex-concave pattern; a second substrate having a second plastic substrate, combined with the first substrate and a thin film transistor formed on the second plastic substrate; and a liquid crystal layer interposed between the first substrate and the second substrate. A pixel transparent electrode layer is formed on the TFT. Provided is a flexible LCD, wherein the reproducibility of a convex-concave pattern is enhanced so that a reflection property is improved.

### CROSS-REFERENCE TO RELATED APPLICATIONS

This application claims priority from Korean Patent Application No. 2005-0099823, filed on Oct. 21, 2005, in the Korean Intellectual Property Office, the disclosure of which is incorporated herein by reference.

### BACKGROUND OF INVENTION

1. Field of Invention

The present invention relates to a flexible liquid crystal display having a plastic substrate applied thereto, and more particularly, to a reflective flexible liquid crystal display, in which natural light is reflected so that an image is formed, and a manufacturing method thereof.

2. Description of the Related Art

A liquid crystal display (LCD) may be classified according to a type of a light source into a transmissive LCD, a transflective LCD, or a reflective LCD. In a transmissive LCD, a backlight unit is arranged on a rear of the liquid crystal panel, with the light emitted from the backlight unit being transmitted into the liquid crystal panel. Because a backlight unit can account for 70% of LCD power consumption, a reflective LCD employs natural light to form an image, advantageously limiting the power consumption of this display. A transflective LCD incorporates advantages of both the transmissive LCD and the reflective LCD, by using both natural light and a backlight unit to provide appropriate luminance despite changing light intensity in the user environment surrounding the display.

Typically, for either a reflective LCD or a transflective LCD, a passivation film is applied on a thin film transistor (TFT) substrate, with a convex-concave pattern being formed on the passivation film, and a reflective layer being formed on the convex-concave pattern. In general, if a reflective layer is formed on the entire surface of the convex-concave pattern, a reflective LCD is manufactured; and if the reflective layer is formed on a portion of the convex-concave pattern, a transflective LCD is manufactured. Here, the convex-concave pattern functions to improve an optical characteristic and enhances front reflexibility of light, so that an image can be formed in an LCD.

In manufacturing a reflective LCD, a flexible reflective LCD has been recently manufactured by substituting a plastic substrate in place of a glass substrate. In general, the plastic substrate exhibits desirable characteristics in terms of being thin, lightweight, impact resistant, and flexible

However, the shape of the plastic substrate may be deformed due to heat and impurities such as gases or chemical substances produced during the manufacturing process. As a result, an organic film on the plastic substrate, and a reflective layer on the organic film, may be deformed thereby degrading a desirable optical or reflective characteristic. Further, the process of forming a convex-concave pattern on the organic film typically suffers from poor reproducibility when using a photo-etching process.

### SUMMARY OF THE INVENTION

Accordingly, embodiments of the present invention can provide a flexible LCD with an improved optical characteristic; and a method of manufacturing a flexible LCD with a simple manufacturing process, in which the process can enhance reproducibility of a convex-concave pattern on the flexible LCD, so that a reflection property is improved.

In selected embodiments and aspects of the present invention, the flexible liquid crystal display (LCD) includes a first substrate, a second substrate, and a liquid crystal layer interposed between the first substrate and the second substrate. The first substrate can be a first plastic substrate having a convex-concave pattern formed thereon and a reflective layer formed on the convex-concave pattern. The second substrate can be a second plastic substrate, which is combined with the first substrate and a thin film transistor (TFT) formed on the second plastic substrate. In selected embodiments, the flexible LCD further includes a color filter, formed between the reflective layer and the liquid crystal layer. In addition, the flexible LCD further can include a common transparent electrode layer interposed between the color filter and the liquid crystal layer, and a pixel transparent electrode layer interposed between the TFT and the liquid crystal layer. Also, in certain embodiments, the flexible LCD further can include a color filter formed on the TFT and a pixel transparent electrode layer formed between the color filter and the liquid crystal layer. Furthermore, the convex-concave pattern can be an embossed shape, formed to protrude from a surface of the first plastic substrate. The convex-concave pattern is uniformly arranged on an entire surface of the first plastic substrate, and the reflective layer is formed on the entire surface of the convex-concave pattern. Additionally, the convex-concave pattern can be given the shape of a concave lens, formed to be depressed from a surface of the first plastic substrate. The second plastic substrate can include a biaxially-oriented plastic film and can have a polarizing film attached on the outer surface of the second substrate. The second plastic substrate is formed to provide a phase difference of λ/4, relative to incident light.

In selected other embodiments and aspects of the present invention, a flexible LCD can include a first substrate having a first plastic substrate, a second plastic substrate, and a liquid crystal layer interposed between the first substrate and the second substrate. The first plastic substrate includes a resin layer, which has a convex-concave pattern formed on the first plastic substrate, and a reflective layer formed on the convex-concave pattern. The resin layer can include an organic material. The second substrate can be a second plastic substrate, which is combined with the first substrate, and a TFT formed on the second plastic substrate. The flexible LCD further can include a color filter formed between the reflective layer and the liquid crystal layer. In addition, the flexible LCD can have a color filter formed on the TFT, and a pixel transparent electrode layer formed between the color filter and the liquid crystal layer. In certain embodiments, the convex-concave pattern can have an embossed shape formed to be protruded from a surface of the resin layer. Also, the convex-concave pattern can include a shape of a concave lens, formed to be depressed from a surface of the resin layer.

In accordance with the present invention, selected embodiments of a method of manufacturing a flexible LCD can include providing a first plastic substrate comprising a convex-concave pattern formed thereon; forming a reflective layer on the convex-concave pattern; and combining to face to each other, a second plastic substrate having a TFT formed thereon with the first plastic substrate. The convex-concave pattern can be formed on the first plastic substrate by pressurizing a mold having a predetermined convex-concave pattern formed thereon. The method of manufacturing can include forming a color filter on the reflective layer; and forming a common transparent electrode layer on the color filter. Alternatively, the method of manufacturing can include forming a color filter on the TFT; and forming a pixel transparent electrode layer on the color filter.

In other selected embodiments of the present invention, a method of manufacturing a flexible LCD can include providing a first plastic substrate; forming a resin layer on the first plastic substrate; forming a convex-concave pattern by aligning a mold having a predetermined convex-concave pattern formed thereon and by pressurizing the mold having the predetermined convex-concave pattern formed thereon; forming a reflective layer on the convex-concave pattern; and combining a second plastic substrate having a TFT formed thereon with the first plastic substrate to face to each other. The method of manufacturing further can include forming a color filter on the reflective layer; and forming a common transparent electrode layer on the color filter. In addition, methods of manufacturing further can include forming a color filter on the TFT; and forming a pixel transparent electrode layer on the color filter.

It is to be understood that both the foregoing general description and the following detailed description are exemplary and explanatory and are intended to provide further explanation of the invention as claimed.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a layout view of a second substrate having a TFT formed thereon according to a first embodiment of the present invention;

FIG. 2 is a cross-sectional view of a flexible LCD taken along line II-II of FIG. 1;

FIG. 3 is a cross-sectional view of a flexible LCD according to a second embodiment of the present invention;

FIG. 4 is a cross-sectional view of a flexible LCD according to a third embodiment of the present invention;

FIG. 5 is a cross-sectional view of a flexible LCD according to a fourth embodiment of the present invention;

FIGS. 6a to 6d are cross-sectional views illustrating a manufacturing method of a flexible LCD according to the first embodiment illustrated in FIGS. 1 and 2;

FIGS. 7a to 7c are cross-sectional views illustrating a manufacturing method of a flexible LCD according to the third embodiment illustrated in FIG. 4; and

FIGS. 8a to 8d are cross-sectional views illustrating a manufacturing method of a flexible LCD according to the fourth embodiment illustrated in FIG. 5.

### DETAILED DESCRIPTION

Reference will now be made in detail to the embodiments of the present invention, examples of which are illustrated in the accompanying drawings, wherein like reference numerals refer to like elements throughout. The embodiments are described below so as to explain the present invention by referring to the figures. It will be understood that if one film (layer) is formed (located) “on the top of” another film (layer), this means not only a case where two films (layers) are in contact with each other but also a case where another film (layer) is interposed between two films (layers).

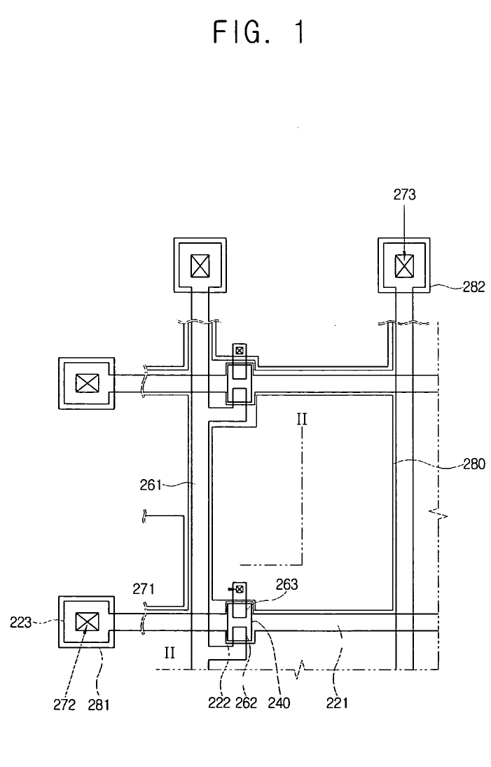

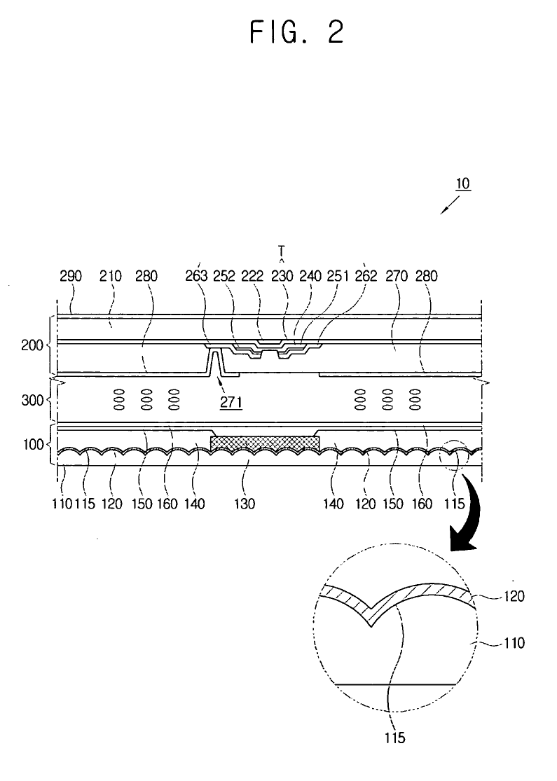

FIG. 1 is a layout view of the second substrate 200 having a TFT T formed thereon according to a first embodiment of the present invention, and FIG. 2 is a cross-sectional view of the flexible LCD 10 taken along line II-II of FIG. 1.

FIG. 2 is a cross-sectional view of an LCD 10 according to the present invention. The LCD 10 comprises a first substrate 100, a second substrate 200 combined to the first substrate 100 to face each other and a liquid crystal layer 300 interposed between the first and the second substrates 100 and 200.

First, the first substrate 100 will now be described with reference to FIG. 2.

On a first plastic substrate 110 is formed a convex-concave pattern 115. In recent years, plastic substrates have become increasingly thin, lightweight, flexible, impact resistant, and inexpensive to manufacture. The first plastic substrate 110 may be made of plastic materials including without limitation polycarbon, polyimide, polyether sulfone (PES), polyarylate (PAR) polyethylenenapthalate (PEN), or polyethylene terephthalate (PET). Although not shown in FIG. 2, on at least one surface of the first plastic substrate 110 may be further formed a barrier layer to prevent gas such as oxygen possible to be incident from the outside and moisture but also to maintain the form of the first plastic substrate 110. A suitable barrier layer may include at least one of SiO₂, SiNx, Al₂O₃, and SiON.

As shown in FIG. 2, the convex-concave pattern 115 is formed on the first plastic substrate 110. An embossed shape formed to protrude from a surface of the first plastic substrate 110, thereby providing the convex-concave pattern 115. The embossed shaped may be of a dot pattern, as well as of a convex lens. Such a convex-concave pattern 115 can be formed to improve an optical characteristic and enhances reflexibility, i.e., the property of incident light to be reflected back, by inducing the diffusion of light. In particular, the convex-concave pattern 115 enhances front reflexibility of light so that an image can be expressed in the LCD 10. The convex-concave pattern 115 is arranged uniformly on an entire surface of the first plastic substrate 110.

On the convex-concave pattern 115 is formed a reflective layer 120. Natural light incident onto the LCD 10 is reflected from the reflective layer 120 and radiated again to the outside of the LCD 10. In this process, the natural light or reflexive light has a color imparted thereto while passing through a color filter 140. The reflective layer 120 can include a reflective material including without limitation, aluminum, or silver. The reflective layer 120 also may be formed of plural layers, for example, with reflective layer 120 having a layer of aluminum formed together with a layer of molybdenum.

Advantageously, the convex-concave pattern 115 can be fabricated easily through a simple molding method. For example, the convex-concave pattern 115 can be formed on a flexible solid such as the first plastic substrate 110 using a molding method to enhance the reproducibility of the convex-concave pattern 115 having an improved optical or reflecting characteristic using photo-etching methods, as compared to a conventional photo-etching method.

A black matrix 130 may function to divide between red, green, and blue filters. The black matrix 130 is usually made of a photosensitive organic material having a black pigment added thereto. Exemplary and suitable black pigments include without limitation carbon black and titanium oxide.

The color filter 140 is formed, usually of a photosensitive organic material, such that red, green, and blue filters are repeated, with the black matrix 130 forming a border. The color filter 140 functions to impart a color to light radiated from a backlight unit (not shown) and then passed through the liquid crystal layer 300.

An overcoat layer 150 is formed on the top of the color filter 140, and the black matrix 130 which is not covered with the color filter. The overcoat layer 150 functions to planarize and protect the color filter 140, and generally is made of an acrylic epoxy material.

On the top of the overcoat is formed a common transparent electrode layer 160. The common electrode layer 160 formed on the first substrate 100 is usually referred to as a common electrode. Typically, the common transparent electrode layer 160 is made of a transparent conductive material, such as, for example, ITO (Indium Tin Oxide) or IZO (Indium Zinc Oxide). The common transparent electrode layer 160 applies a voltage directly to the liquid crystal layer 300, together with a pixel transparent electrode layer 280 of the second substrate 200.

Next, the second substrate 200 according to the first embodiment of the present invention will be described below.

As shown in FIGS. 1 and 2, gate wiring 221, 222, and 223 is formed on a second plastic substrate 210.

In recent years, plastic substrates have become increasingly thin, lightweight, flexible, impact resistant, and inexpensive to manufacture. The second plastic substrate 210 may be made of suitable plastics, including without limitation, polycarbonate, polyimide, polyether sulfone (PES), polyarylate (PAR) polyethylenenapthalate (PEN), or polyethylene terephthalate (PET). Although not shown in this figure, on at least one surface of the second plastic substrate 210 may be further formed a barrier layer to prevent gas such as oxygen possible to be incident from the outside and moisture but also to maintain the form of the first plastic substrate 110. A suitable barrier layer may include at least one of SiO₂, SiNx, Al₂O₃, and SiON. The barrier layer functions not only to prevent moisture and a gas, such as oxygen, to be incident from the outside, but also to assist with maintaining the form of the second plastic substrate 210.

The second plastic substrate 210 according to the present invention may be a phase difference film or a substrate capable of imparting upon light passing through the second plastic substrate 210, a phase difference of λ/4, relative to incident light. Further, the second plastic substrate 210 may include a biaxially-oriented plastic film. In general, a biaxially oriented plastic film is a plastic film or substrate fabricated by applying directional tension at an appropriate temperature so that molecular arrangements thereof are made in the direction of the tension, and further by applying tension in two directions perpendicular to each other. Such a biaxial orientation can impart a phase difference of λ/4 to the second plastic substrate 210 or film. The oriented substrate or film may provide improved physical performance by exhibiting relatively large tensile strength with respect to an oriented direction of the biaxially-oriented film, as compared with a non-oriented film or substrate.

The gate wiring 221, 222 and 223 may be formed from a single metallic layer or, in the alternative, formed from multiple metallic layers. The gate wiring 221, 222 and 223 includes a gate line 221 extended to a lateral direction, a gate electrode 222 connected to the gate line 221 and a gate pad 223 connected to a gate driver (not shown) to receive a driving signal.

A gate insulation film 230 made of a suitable gate insulator including without limitation silicon nitride (SiNx) covers the gate wiring 221, 222, and 223 on the second plastic substrate 210.

A semiconductor layer 240 is formed on the top of the gate insulation film 230 of the gate electrode 222. Layer 240 can be made of a semiconductor such as polycrystalline silicon. Ohmic contact layers 251 and 252 are formed on the top of the semiconductor layer 240. Layers 251 and 252 can be made of a stable contact material such as a silicide or an n⁺ hydrogenated polycrystalline silicon, doped with a high concentration of n-type impurities. Further, it may be desirable to remove the ohmic contact layers 251 and 252 from a channel portion between source electrode 262 and drain electrodes 263.

Data wiring 261, 262 and 263 is formed on the ohmic contact layers 251 and 252, and the gate insulation film 230. The data wiring 261, 262 and 263 may be formed from a single metallic layer or, in the alternative, formed from multiple metallic layers. Data line 261 is formed in a longitudinal direction, which generally is perpendicular to, and crosses the gate line 221. A branch of the data line 261 can be extended to the top of the ohmic contact layers 251 and 252 to form a source electrode 262. A drain electrode 263 is formed from data wiring on the top of the ohmic contact layers 251 and 252 opposite to the source electrode 262, and is separated from the source electrode 262. A pixel is formed from source electrode 262, drain electrode 263, and a gate electrode 222.

A passivation film 270 is formed on the top of the data wiring 261, 262, and 263, as well as a portion of the semiconductor layer 240, which is not covered with the data wiring 261, 262, and 263. On the passivation film 270 are formed a drain contact hole 271, a gate pad contact hole 272, and a data pad contact hole 273. Hole 271 exposes the drain electrode 263. The gate pad contact hole 272 allows a connection with a gate driver (not shown) so that a gate driving signal can be applied to gate line 221. Similarly, a data pad contact hole 273 allows a connection with a data driver (not shown) so that a data driving signal can be applied to data line 261. At this time, an inorganic insulation film such as silicon nitride may be further formed between the passivation film 270 and the TFT T, to enhance the reliability of the TFT T. Desirably, the passivation film 270 may be a highly viscous organic material layer in a manner that is capable of maintaining a predetermined shape.

Typically, pixel transparent electrode layer 280 is made of a transparent conductive material such as ITO (Indium Tin Oxide) or IZO (Indium Zinc Oxide). The pixel transparent electrode layer 280 formed on the second plastic substrate 210 is connected to the drain electrode 263 through the drain contact hole 271. The pixel transparent electrode layer 280 also may be called the pixel electrode. Further, contact auxiliary members 281 and 282 are formed on the gate and data pad contact holes 272 and 273, respectively. The contact auxiliary members 281 and 282 usually are made of a transparent conductive material including without limitation an ITO (Indium Tin Oxide) material or an IZO (Indium Zinc Oxide) material.

A polarizing plate 290 can be attached on the outer surface of the second plastic substrate 210.

Further, the liquid crystal layer 300 is located between both substrates 100 and 200. Both substrates 100 and 200 can be bonded with a sealant (not shown).

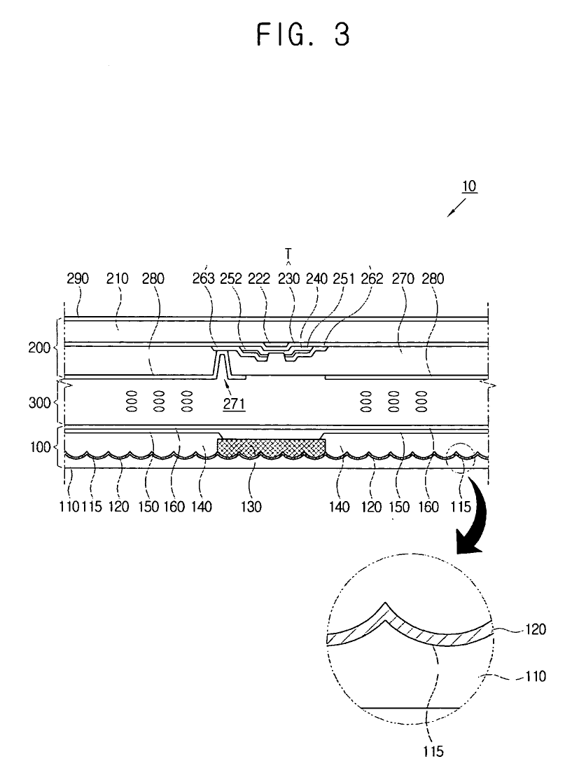

A flexible LCD according to a second embodiment of the present invention will be described below with reference to FIG. 3. In the second embodiment, only elements distinguished from the first embodiment will be described, with elements having a description similar to the foregoing being omitted. Further, like reference numerals indicate like elements for convenience of illustration.

As shown in FIG. 3, a convex-concave pattern 115 formed on a first plastic substrate 110 is a shape of a concave lens formed to be depressed from a surface of the first plastic substrate 110. The convex-concave pattern 115 is uniformly arranged on an entire surface of the first plastic substrate 110 and enhances reflexibility by inducing the diffusion of light. In particular, the convex-concave pattern 115 enhances front reflexibility of light so that an image can be expressed in the LCD 10.

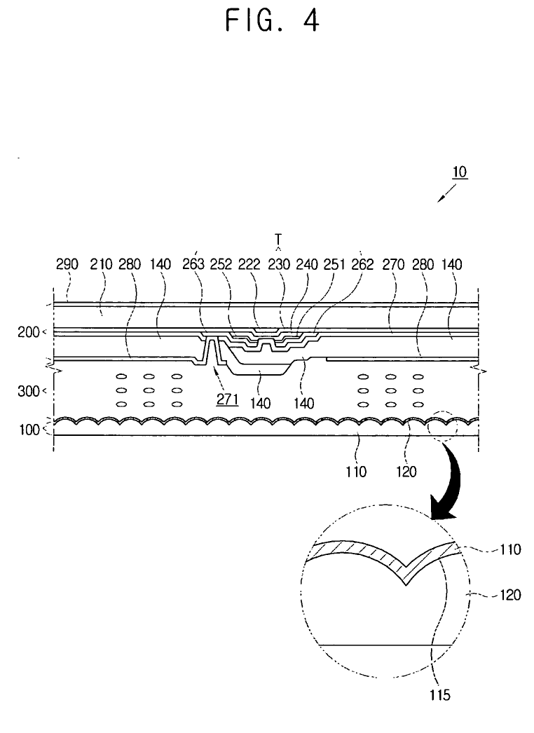

A flexible LCD according to a third embodiment of the present invention will be described below with reference to FIG. 4. In the third embodiment, only elements distinguished from the first embodiment will be described, and the remainder of which descriptions are omitted will follow the same descriptions as the first embodiment. Further, like reference numerals indicate like elements for convenience of illustration.

First, a first substrate 100 includes a first plastic substrate 110 having a convex-concave pattern 115 formed thereon and a reflective layer 120 formed on the convex-concave pattern 115. Here, the reflective layer 120 functions not only to reflect light incident inside the LCD 10, but also to control the arrangement of a liquid crystal layer 300 as a common electrode.

Next, in a second substrate 200, a color filter 140 is formed on the top of a passivation film 270. The color filter 140 is formed such that red, green and blue, or cyan, magenta and yellow are repeated. The color filters 140 of two colors are overlapped on the top of a TFT T so that the overlapped portion functions as a black matrix. Accordingly, the black matrix is not formed on the second substrate 200.

On the top of the color filter 140 is formed a pixel transparent electrode layer 280 made of ITO (Indium Tin Oxide) or IZO (Indium Zinc Oxide). The pixel transparent electrode layer 280 is connected to a drain electrode 263 through a contact hole 271, and the pixel transparent electrode layer 280 formed on the second substrate 200 usually is referred to as a pixel electrode.

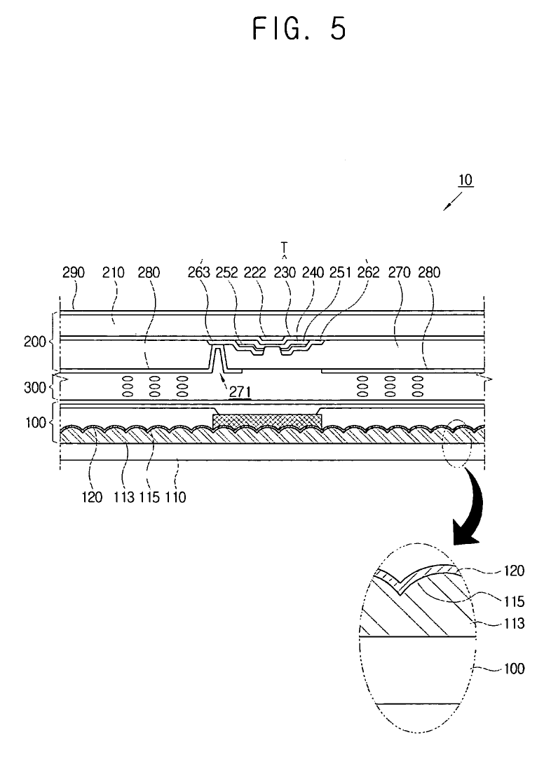

A flexible LCD according to a fourth embodiment of the present invention will be described below with reference to FIG. 5. In the fourth embodiment, only elements distinguished from the first embodiment will be described, with the remainder of which descriptions are omitted will follow the same descriptions as the first embodiment. Further, like reference numerals indicate like elements for convenience of illustration.

As shown in FIG. 5, a resin layer 113 is applied on a flat first plastic substrate 110, and a convex-concave pattern 115 is on the top surface of the resin layer 113. Further, a reflective layer 120 is formed on the convex-concave pattern 115. Here, the convex-concave pattern 115 is formed by means of molding, and the resin layer 113 may be an organic film.

A manufacturing method of a flexible LCD according to the first embodiment of the present invention will be described below.

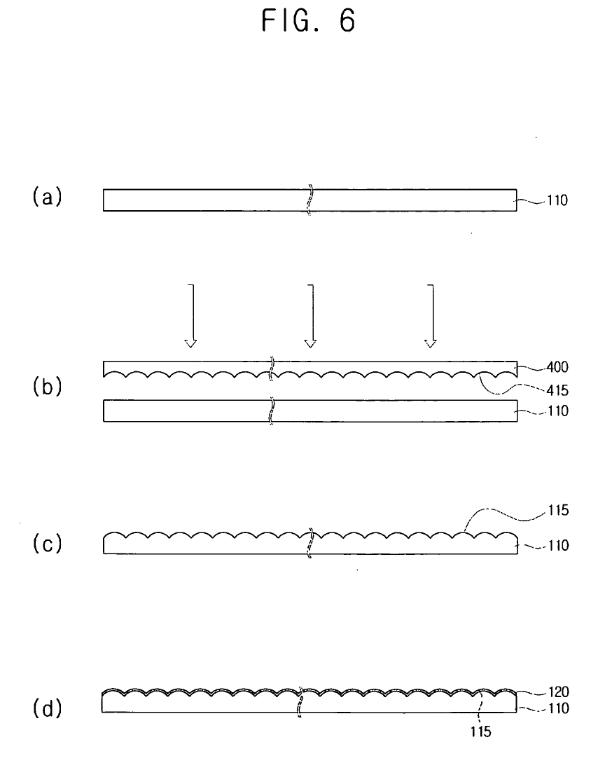

First, a manufacturing method of a first substrate 100 according to the first embodiment of the present invention will be described with reference to FIGS. 6a to 6d. In the following description, only distinguished elements of the present invention will be described, and the remainder of which descriptions are omitted will follow the same descriptions as a known method.

First, a first plastic substrate 110 is provided as shown in FIG. 6a. The first plastic substrate 110 may be made of a plastic including without limitation polycarbonate, polyimide, polyether sulfone (PES), polyarylate (PAR) polyethylenenapthalate (PEN), and polyethylene terephthalate (PET). First plastic substrate 110 may be selected without particular regard to transparency and phase difference properties.

Next, as shown in FIG. 6b, a mold 400 is aligned on the provided first plastic substrate 110 and pressurized toward the first plastic substrate 110. Here, a convex-concave pattern 415 corresponding to a convex-concave pattern 115 to be formed on the first plastic substrate 110 is formed on one surface of the mold 400 pressurized toward the first plastic substrate 110.

Through this, as shown in FIG. 6c, the convex-concave pattern 115 formed uniformly is formed on an entire surface of the first plastic substrate 110. Here, the convex-concave pattern 115 is an embossed shape as shown in FIG. 6c. Contrary thereto, the convex-concave pattern 115 may be formed as a shape of a concave lens.

Further, as shown in FIG. 6d, a reflective layer 120 using aluminum or silver is formed on the convex-concave pattern 115. Depending on a case, the reflective layer 120 may be formed as a double layer of aluminum/molybdenum.

Subsequently, although not shown in this figure, on the reflective layer 120 are sequentially formed a black matrix 130, a color filter 140, an overcoat layer 150 and a common transparent electrode layer 160 through a known method so that a first substrate 100 is completed.

According thereto, the convex-concave pattern 115 can be fabricated through a simple molding method, and the convex-concave pattern 115 is formed on the first plastic substrate 110, which is in a state of a flexible solid, through a molding method so that the reproducibility of the convex-concave pattern 115 is enhanced as compared with a conventional photo etching method, thereby improving an optical or reflecting characteristic.

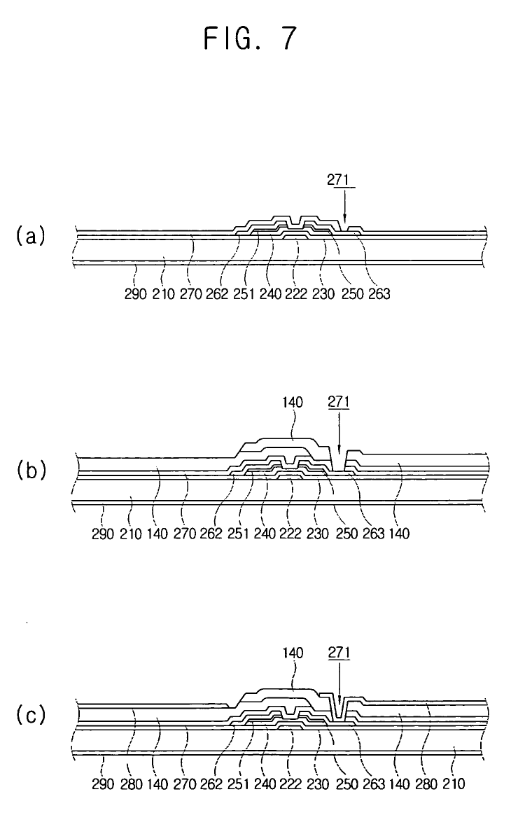

A manufacturing method of a second substrate 200 according to the third embodiment of the present invention will be described below with reference to FIGS. 7a to 7c. In the following description, only elements distinguished from foregoing descriptions of the present invention will be described, and the remainder of which descriptions are omitted will follow the same descriptions as a known method.

First, as shown in FIG. 7a, a gate wiring material is deposited on a second plastic substrate 210 through a conventional method and then patterned through a photo etching process using a mask so that gate wiring such as a gate line 221, a gate electrode 222, and a gate pad 223 are formed. Next, a layer of gate insulation film 230 is formed, upon which a semiconductor layer 240 is formed. In turn, atop semiconductor layer 240, ohmic contact layers 251 and 252 are continuously laminated. In consideration that the second substrate 210 is a plastic, it is desirable to use a LTPS (Low Temperature Polysilicon) method to form the gate wiring 221, 222, and 223. Alternatively, a sputtering method or a CVD method may be used.

The semiconductor layer 240 and ohmic contact layers 251 and 252 then may be photo-etched so that the semiconductor layer 240 is formed on the gate insulation film 230, and the gate insulation film 230 is formed on the top of the gate electrode 222. Here, the ohmic contact layers 251 and 252 are formed on the semiconductor layer 240.

Next, a data wiring material is deposited through the LTPS method and then, using a mask, patterned through a photo etching process so that a data wiring 261, 262 and 263 are formed. Data line 261 is formed to cross the gate line 221, and to extend so that a source electrode 262 is formed from the data line 261. Desirably, a drain electrode 263 is formed from the data wiring material and disposed to face source electrode 262. Alternatively, the data wiring 261, 262 and 263 may be formed through CVD or sputtering method. Subsequently, where not covered with the data wiring 261, 262 and 263, ohmic contact layers 251 and 252 are etched so that the semiconductor layer 240 is exposed, and so that they are separated from the gate electrode 222 and. In this process, a portion of the semiconductor layer 240 may be etched and the ohmic contact layers 251 and 252 may be mostly removed. Furthermore, it is desirable to stabilize the exposed surface of the semiconductor layer 240 by an oxygen plasma treatment.

A passivation film 270 is formed through suitable methods including without limitation a spin coating or a slit coating method. Further, an inorganic insulation film, such as silicon nitride, may be formed between the passivation film 270 and a TFT T, to enhance the reliability of the TFT T. Desirably, the passivation film 270 may be composed of an organic material that is capable of maintaining a predetermined shape. Further, a drain contact hole 271 is photo etched into the passivation film 270 for exposing the drain electrode 263.

Subsequently, as shown in FIG. 7b, each color filter 140 of red, green and blue, or of cyan, magenta and yellow may be formed repeatedly on the passivation film 270. The color filter 140 may be formed, for example, through a slit coating method or a spin coating method. Conveniently, color filter 140 can be formed such that the color filters 140 of two colors are overlapped, thereby allowing the overlapped portion of the color filters 140 to function as a black matrix, and thus the black matrix is not formed on the second substrate 200. Further, a drain contact hole 271 is formed on the color filter 140 through a photo etching process in order to expose the drain electrode 263. Moreover, although not shown in this figure, the color filter 140 may be formed through an inkjet method. In this case, if the black matrix is disposed to form a barrier wall, the color filter 140 may be formed by jetting color filter material inside the barrier wall.

As shown in FIG. 7c, a transparent electrode material such as ITO (Indium Tin Oxide) or IZO (Indium Zinc Oxide) can be deposited on the color filter 140, and then photo-etched, so that the drain contact hole 271 is formed, allowing a pixel transparent electrode layer 280 to be connected with the drain electrode 263.

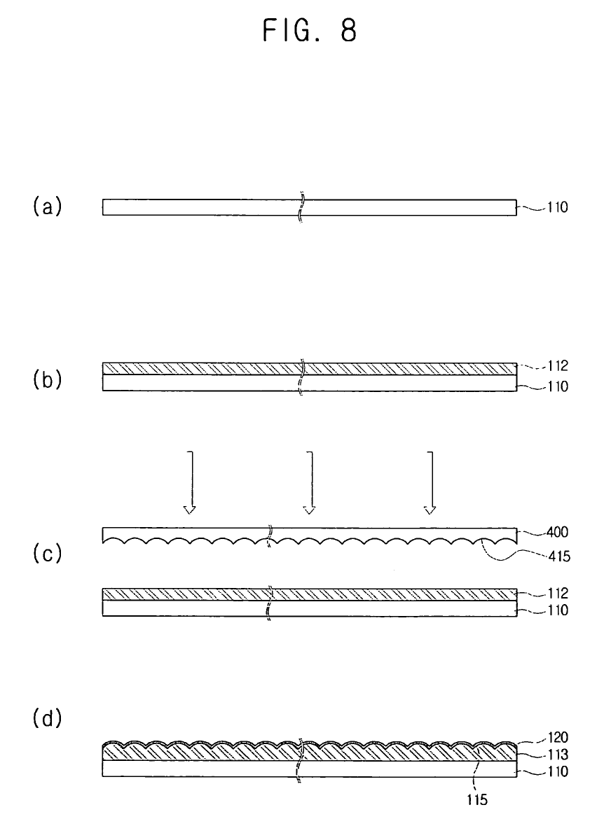

A manufacturing method of a first substrate 100 according to the fourth embodiment of the present invention will be described below with reference to FIGS. 8a to 8d. In the following description, only elements distinguished from foregoing discussions of the present invention will be described, with the remainder of descriptions following the same descriptions as a known method being omitted.

As shown in FIG. 8a, a first plastic substrate 110 can be provided of which the top surface is flat.

Subsequently, as shown in FIG. 8b, a resin material 112 is applied on the first plastic substrate 110 through a suitable coating method, such as a slit coating method or a spin coating method. The resin material 112 may be an organic material. In addition, the resin material 112 may be applied through a screen printing method.

Next, as shown in FIG. 8c, a mold 400 is aligned on the first plastic substrate 110 having the resin material 112 applied thereon, and pressurized toward the first plastic substrate 110. Advantageously, a convex-concave pattern 415, corresponding to the convex-concave pattern 115 formed on the first plastic substrate 110, for example, as in FIG. 2, is formed on one surface of the mold 400 that is pressurized toward the first plastic substrate 110.

Thus, as shown in FIG. 8d, the convex-concave pattern 115 is formed uniformly on an entire surface of the first plastic substrate 110. In FIG. 8d, the convex-concave pattern 115 is an embossed shape. Alternatively, the convex-concave pattern 115 may be formed in the shape of a concave lens. Subsequently, a reflective layer 120 using aluminum or silver is formed on the convex-concave pattern 115. Alternatively, the reflective layer 120 may be formed as a double layer, including an aluminum layer and a molybdenum layer.

Next, although not shown in this figure, a black matrix 130, a color filter 140, an overcoat 150 and a common transparent electrode layer 160 are sequentially formed on the reflective layer 120 using a known method.

Accordingly, there is provided a flexible LCD having a convex-concave pattern exhibiting an improved a reflection property, wherein the reproducibility of a convex-concave pattern is enhanced.

Furthermore, there is provided a manufacturing method of a flexible LCD with a simple manufacturing process.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A flexible liquid crystal display (LCD), comprising:
a first substrate comprising a first plastic substrate having a convex-concave pattern formed thereon and a reflective layer formed on the convex-concave pattern;
a second substrate having a second plastic substrate having a thin film transistor (TFT) formed thereon, wherein the second plastic substrate is combined with the first substrate; and
a liquid crystal layer interposed between the first substrate and the second substrate.

2. The flexible LCD according to claim 1, further comprising a color filter formed between the reflective layer and the liquid crystal layer.

3. The flexible LCD according to claim 1, further comprising a common transparent electrode layer between the color filter and the liquid crystal layer, and a pixel transparent electrode layer between the TFT and the liquid crystal layer.

4. The flexible LCD according to claim 1, further comprising a color filter formed on the TFT and a pixel transparent electrode layer formed between the color filter and the liquid crystal layer.

5. The flexible LCD according to claim 1, wherein the convex-concave pattern comprises an embossed shape formed to be protruded from a surface of the first plastic substrate.

6. The flexible LCD according to claim 1, wherein the convex-concave pattern comprises a shape of a concave lens formed to be depressed from a surface of the first plastic substrate.

7. The flexible LCD according to claim 1, wherein the second plastic substrate is formed so that light passing through the second plastic substrate has a phase difference of λ/4.

8. The flexible LCD according to claim 1, wherein the second plastic substrate comprises a biaxially-oriented plastic film.

9. The flexible LCD according to claim 1, wherein a polarizing film is attached on the outer surface of the second substrate.

10. The flexible LCD according to claim 1, wherein the convex-concave pattern is uniformly arranged on an entire surface of the first plastic substrate, and the reflective layer is formed on the entire surface of the convex-concave pattern.

11. A flexible LCD, comprising:
a first substrate comprising
a first plastic substrate,
a resin layer comprising a convex-concave pattern formed on the first plastic substrate, and
a reflective layer formed on the convex-concave pattern;
a second substrate comprising a second plastic substrate which is combined with the first substrate and a TFT formed on the second plastic substrate; and
a liquid crystal layer interposed between the first substrate and the second substrate.

12. The flexible LCD according to claim 11, wherein the resin layer comprises an organic material.

13. The flexible LCD according to claim 11, further comprising a color filter formed between the reflective layer and the liquid crystal layer.

14. The flexible LCD according to claim 11, further comprising a color filter formed on the TFT and a pixel transparent electrode layer formed between the color filter and the liquid crystal layer.

15. The flexible LCD according to claim 11, wherein the convex-concave pattern has an embossed shape formed to be protruded from a surface of the resin layer.

16. The flexible LCD according to claim 11, wherein the convex-concave pattern a shape of a concave lens formed to be depressed from a surface of the resin layer.

17. A manufacturing method of a flexible LCD, the method comprising:
providing a first plastic substrate comprising a convex-concave pattern formed thereon;
forming a reflective layer on the convex-concave pattern; and
combining a second plastic substrate having a TFT formed thereon with the first plastic substrate to face to each other.

18. The method according to claim 17, wherein the convex-concave pattern is formed on the first plastic substrate by pressurizing a mold having a predetermined convex-concave pattern formed thereon.

19. The method according to claim 17, further comprising:
forming a color filter on the reflective layer; and
forming a common transparent electrode layer on the color filter.

20. The method according to claim 17, further comprising:
forming a color filter on the TFT; and
forming a pixel transparent electrode layer on the color filter.

21. A manufacturing method of a flexible LCD, the method comprising:
providing a first plastic substrate;
forming a resin layer on the first plastic substrate;
forming a convex-concave pattern by aligning and pressurizing a mold having a predetermined convex-concave pattern formed thereon;
forming a reflective layer on the convex-concave pattern; and
combining a second plastic substrate having a TFT formed thereon with the first plastic substrate to face to each other.

22. The method according to claim 21, further comprising:
forming a color filter on the reflective layer; and
forming a transparent electrode layer on the color filter.

23. The method according to claim 21, further comprising:
forming a color filter on the TFT; and
forming a pixel transparent electrode layer on the color filter.
